(19) United States
(12) Patent Application Publication
(10) Pub. No.: US 2014/0146075 A1
(43) Pub. Date: May 29, 2014

(54) Electronic Apparatus and Display Control Method

(71) Applicant: Kabushiki Kaisha Toshiba, Tokyo (JP)

(72) Inventor: Nobuaki Takasu, Akishima-shi (JP)

(21) Appl. No.: 13/942,236

(22) Filed: Jul. 15, 2013

(30) Foreign Application Priority Data
Nov. 29, 2012 (JP) 2012-260830

(51) Int. Cl. G09G 5/00; G02B 27/01

(52) U.S. Cl. CPC G09G 5/006; G02B 27/017
USPC 345/619

(57) ABSTRACT

According to one embodiment, an electronic apparatus includes a display controller, a state determination module and an area setting module. The display controller displays first information on a screen of a head-mounted display worn by a user. The state determination module determines whether the user is moving or not. The area setting module sets a first area and a second area in the screen based on a line of sight of the user if the user is moving. The display controller displays, in response to the setting of the first area and the second area, second information in the first area and deletes information displayed in the second area from the screen, the first information including the second information.

### CROSS-REFERENCE TO RELATED APPLICATIONS

This application is based upon and claims the benefit of priority from Japanese Patent Application No. 2012-260830, filed Nov. 29, 2012, the entire contents of which are incorporated herein by reference.

### FIELD

Embodiments described herein relate generally to an electronic apparatus which is connectable to a head-mounted display, and a display control method applied to the electronic apparatus.

### BACKGROUND

In recent years, various techniques have been proposed for realizing augmented reality (AR) in which information is seamlessly overlapped with a real world. In the AR technique, for example, by using a transmissive head-mounted display (HMD), information is superimposed on the real world. A user wearing the transmissive HMD can view, along with the real word (real environment) which is viewed through the HMD, various kinds of electronic information displayed on the HMD.

Thus, the transmissive HMD can be used for presenting information, such as direction boards, to the user who is moving in the real world.

However, when information is presented on the display in a manner to hinder a view field, or when the user pays too much attention to the information on the display, there is a possibility that a danger occurs to the moving user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic apparatus according to an embodiment.

FIG. 2 is an exemplary block diagram illustrating a system configuration of the electronic apparatus of the embodiment.

FIG. 3 is an exemplary block diagram illustrating a configuration for controlling display of an HMD by the electronic apparatus of the embodiment.

FIG. 4 is an exemplary block diagram illustrating a functional configuration of an HMD application program executed by the electronic apparatus of the embodiment.

FIG. 5 is a view illustrating an example of a screen displayed on the HMD of FIG. 3 by the electronic apparatus of the embodiment, when a user is not moving.

FIG. 6 is a view illustrating an example of a screen displayed on the HMD of FIG. 3 by the electronic apparatus of the embodiment, when the user is moving.

FIG. 7 is a view illustrating another example of the screen displayed on the HMD of FIG. 3 by the electronic apparatus of the embodiment, when the user is moving.

FIG. 8 is a view illustrating still another example of the screen displayed on the HMD of FIG. 3 by the electronic apparatus of the embodiment, when the user is moving.

FIG. 9 is a view illustrating an example of a screen displayed on the HMD of FIG. 3 by the electronic apparatus of the embodiment, when the user is moving with a high velocity.

FIG. 10 is a view illustrating an example in which it has been detected that the user, while moving, gazes at information in the screen displayed on the HMD of FIG. 3 by the electronic apparatus of the embodiment.

FIG. 11 is an exemplary block diagram illustrating a configuration for further controlling an audio output by the electronic apparatus of the embodiment.

FIG. 12 is a flowchart illustrating an example of the procedure of a display control process executed by the electronic apparatus of the embodiment.

FIG. 13 is a flowchart illustrating another example of the procedure of the display control process executed by the electronic apparatus of the embodiment.

### DETAILED DESCRIPTION

Various embodiments will be described hereinafter with reference to the accompanying drawings.

In general, according to one embodiment, an electronic apparatus includes a display controller, a state determination module and an area setting module. The display controller is configured to display first information on a screen of a head-mounted display worn by a user. The state determination module is configured to determine whether the user is moving or not. The area setting module is configured to set a first area and a second area in the screen based on a line of sight of the user if the user is moving. The display controller is configured to display, in response to the setting of the first area and the second area, second information in the first area and to delete information displayed in the second area from the screen, the first information including the second information.

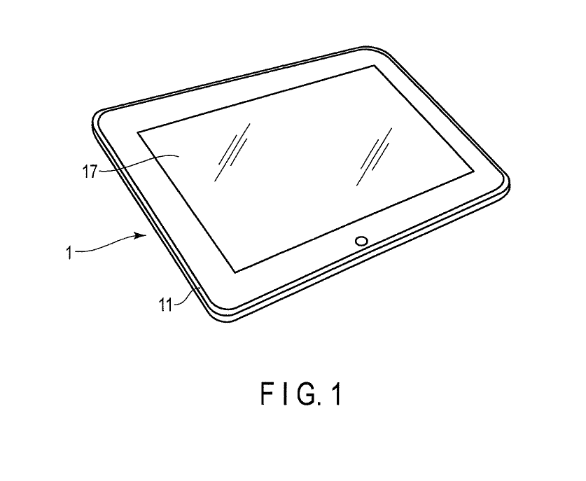

FIG. 1 is a perspective view illustrating an external appearance of an electronic apparatus according to an embodiment. The electronic apparatus is, for instance, a portable electronic apparatus. This electronic apparatus may be realized as a tablet computer, a notebook-type personal computer, a smartphone, a PDA, etc. In the description below, the case is assumed that this electronic apparatus is realized as a tablet computer 1. The tablet computer 1 is a portable electronic apparatus which is also called “tablet” or “slate computer”. As shown in FIG. 1, the tablet computer 1 includes a main body 11 and a touch-screen display 17. The touch-screen display 17 is attached such that the touch-screen display 17 is laid over the top surface of the main body 11.

The main body 11 has a thin box-shaped housing. In the touch-screen display 17, a flat-panel display and a sensor, which is configured to detect a touch position of a finger on the screen of the flat-panel display, are assembled. The flat-panel display may be, for instance, a liquid crystal display (LCD). As the sensor, for example, use may be made of an electrostatic capacitance-type touch panel.

The touch panel is provided in a manner to cover the screen of the flat-panel display. The touch-screen display 17 can detect a touch operation on the screen with use of a finger.

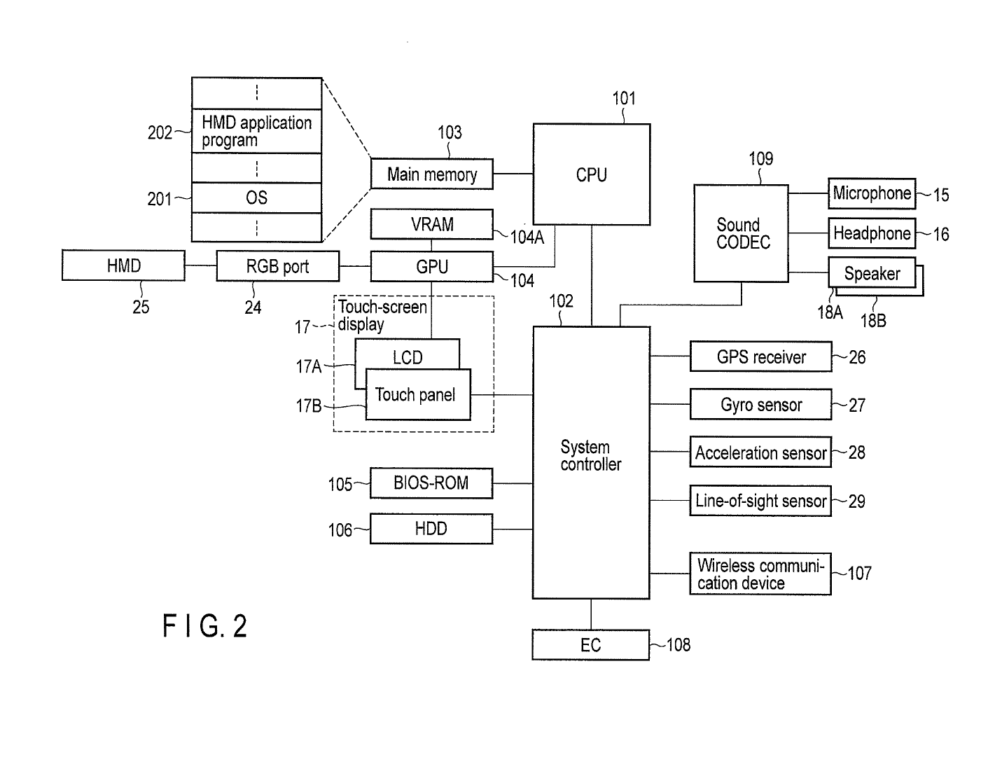

FIG. 2 shows a system configuration of the computer 1.

The computer 1 includes a CPU 101, a system controller 102, a main memory 103, a graphics processing unit (GPU) 104, a BIOS-ROM 105, a hard disk drive (HDD) 106, a wireless communication device 107, an embedded controller IC (EC) 108, and a sound CODEC 109.

The CPU 101 is a processor which controls the operations of the respective components in the computer 1. The CPU 101 executes various kinds of software, which are loaded from the HDD 106 into the main memory 103. The software includes an operating system (OS) 201 and various application programs. The application programs include an HMD application program 202. The HMD application program 202 is a program for executing a function of controlling information (electronic information) displayed on an HMD 25.

In addition, the CPU 101 executes a basic input/output system (BIOS) stored in the BIOS-ROM 105 that is a nonvolatile memory. The BIOS is a system program for hardware control.

The GPU 104 is a display controller which controls an LCD 17A that is used as a display monitor of the computer 1. The GPU 104 generates a display signal (LVDS signal), which is to be supplied to the LCD 17A, from display data stored in a video memory (VRAM) 104A. Further, the GPU 104 generates an analog RGB signal and an HDMI video signal from the display data. The GPU 014 supplies the analog RGB signal to the head-mounted display (HMD) 25 via an RGB port 24. In the meantime, the GPU 104 may send an HDMI video signal (non-compressed digital video signal) and a digital audio signal to the HMD 25 via an HDMI output terminal over a single cable.

The HMD 25 is a transmissive HMD. On a display of the HMD 25, a real world is transmitted, and video (image) based on a video signal, which is sent by the GPU 104, is displayed. When the user wears the HMD 25, the display of the HMD 25 is disposed, for example, in front of the eye of the user. The user wearing the HMD 25 can view both the real world viewed through the display, and various information displayed on the display. Specifically, the user can view the information laid over (overlapped with) the real world. The displayed information is, for instance, location-dependent information (e.g. information on directions, information on nearby facilities) which is suited to the user who is moving. Thus, the above-described HMD application program 202 executes such control that, for example, the HMD 25 displays information corresponding to a position of movement of the user in accordance with the movement of the user.

The system controller 102 is a bridge device which connects the CPU 101 and the respective components. The system controller 102 includes a serial ATA controller for controlling the hard disk drive (HDD) 106. In addition, the system controller 102 communicates with devices on an LPC (Low PIN Count) bus.

Besides, the system controller 102 is connected to a GPS receiver 26, a gyro sensor 27, an acceleration sensor 28 and a line-of-sight sensor 29 via a serial bus such as a USB. The GPS receiver 26 receives GPS data transmitted from a plurality of GPS satellites. Using the received GPS data, the GPS receiver 26 calculates the present position, height, etc. of the user. The GPS receiver (position sensor) 26 outputs position data indicative of the position of the user to the system controller 102, for example, at regular time intervals (e.g. in every second).

The gyro sensor 27 detects an angular velocity. The gyro sensor 27 outputs data indicative of the angular velocity to the system controller 102.

The acceleration sensor 28 detects an acceleration of movement of the user. The acceleration sensor 28 is, for instance, a three-axis acceleration sensor which detects accelerations in three axes (X, Y, Z). Using the detected acceleration, the acceleration sensor 28 can also detect the moving velocity of the user. The acceleration sensor (velocity sensor) 28 outputs velocity data indicative of the moving velocity of the user to the system controller 102, for example, at regular time intervals (e.g. in every 0.1 second).

Each of the GPS receiver 26, gyro sensor 27 and acceleration sensor 28 may be built in the computer main body 11, or may be connected by wire via various terminals provided on the computer 1. In addition, each of the GPS receiver 26, gyro sensor 27 and acceleration sensor 28 may be wirelessly connected to the computer 1 via a communication module of, e.g. Bluetooth (trademark) provided on the computer 1.

The line-of-sight sensor 29 detects a line of sight of the user who wears the HMD 25. By using the detected line of sight, the line-of-sight sensor 29 can specify which area of the display (screen) of the HMD 25 the user is viewing. The line-of-sight sensor 29 is attached to, for example, an upper part of the HMD 25 in a direction in which the line of sight can be detected. For example, in the case where the HMD 25 is realized in a shape of eyeglasses, the line-of-sight sensor 29 is attached to an upper part of a lens portion in a direction in which the user's eye can be detected. Incidentally, the line-of-sight sensor 29 may be built in the display (screen) of the HMD 25. The line-of-sight sensor 29 outputs line-of-sight data indicative of the line of sight of the user to the system controller 102.

The data, which is output by the above-described various sensors, is used by, for example, the HMD application program 202.

The system controller 102 also includes a function of communicating with the sound CODEC 109. The sound CODEC 109 is a sound source device and outputs audio data, which is a target of playback, to a headphone 16 or speakers 18A and 18B. In addition, the sound CODEC 109 outputs data of audio, which has been detected by a microphone 15, to the system controller 102.

The EC 108 is connected to an LPC bus. The EC 108 is realized as a one-chip microcomputer including a power management controller for executing power management of the computer 1. The EC 108 includes a function of powering on and powering off the computer 1 in accordance with an operation of a power button by the user.

The wireless communication device 107 is a device configured to execute wireless communication such as wireless LAN or 3G mobile communication.

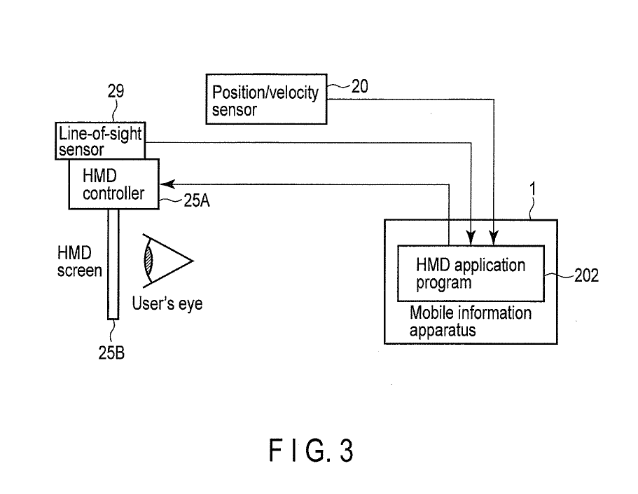

As illustrated in FIG. 3, the HMD application program 202, which is executed on the computer (mobile information apparatus) 1, controls a configuration (arrangement) of information displayed on a screen 25B of the HMD 25. The HMD application program 202 controls the configuration by using data (e.g. position data and velocity data) output by a position/velocity sensor 20 including the GPS receiver 26, gyro sensor 27 and acceleration sensor 28, and line-of-sight data output by the line-of-sight sensor 29. The HMD application program 202 generates a video signal by taking into account whether the user is moving or not (movement state), the moving velocity of the user, and the line of sight of the user, and sends the video signal to a display controller 25A of the HMD 25. Then, the HMD display controller 25A displays video (image) based on the received video signal on the HMD screen 25B. Thereby, information can safely be presented to the user who wears the HMD 15 and is moving.

The position/velocity sensor 20 is not limited to the GPS receiver 26, gyro sensor 27 and acceleration sensor 28. As the position/velocity sensor 20, use may be made of various kinds of sensors which can detect the position of the user and the moving velocity of the user.

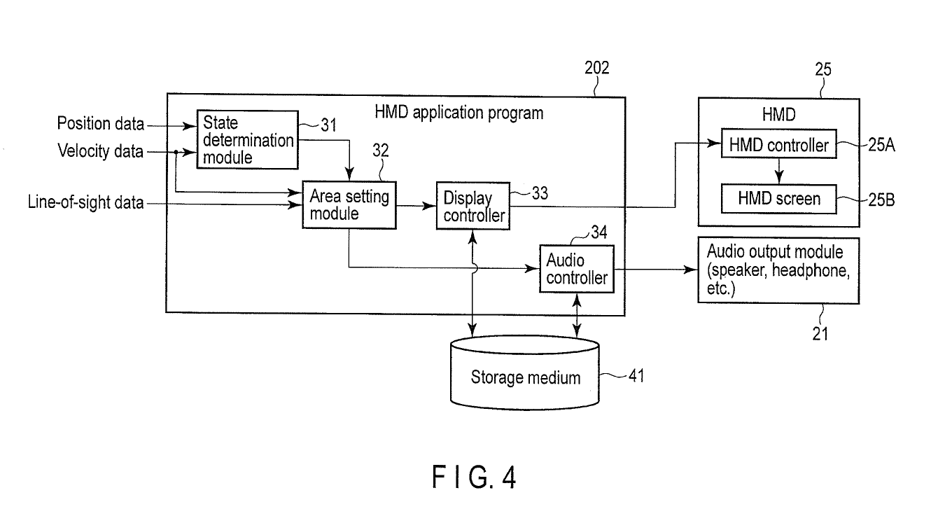

FIG. 4 illustrates a functional configuration of the HMD application program 202 executed on the computer 1. It is assumed that the user is wearing the HMD 25, which is the control target by the HMD application program 202. The HMD application program 202 includes, for example, a state determination module 31, an area setting module 32, a display controller 33 and an audio controller 34.

The state determination module 31 receives position data indicative of the position of the user, which is output by the position sensor (e.g. GPS receiver 26), and determines whether the user is moving or not (movement state) by using the received position data. The state determination module 31 monitors the position data, for example, for only a predetermined period (e.g. several seconds), and determines the movement state of the user by using the monitored position data. Based on the determination result, the state determination module 31 notifies the area setting module 32 either that the user is moving or that the user is not moving (the user stands still).

In the meantime, the state determination module 31 may receive the position data indicative of the position of the user, which is output by the position sensor (e.g. GPS receiver 26), and the velocity data indicative of the moving velocity of the user, which is output by the velocity sensor (e.g. acceleration sensor 28). Then, the state determination module 31 may determine whether the user is moving or not, by using the received position data and velocity data. For the determination of the movement state, use may also be made of angular velocity data output by the gyro sensor 27.

The area setting module 32 sets one or more areas on the HMD display (screen) 25B, based on the movement state of the user and the line of sight of the user. The area setting module 32 sets an area so as not to prevent the user from viewing the real world which is transmitted by the HMD screen 25B, and so as to display much information on the HMD screen 25B. The set area is at least one of a full display area, a non-display area, and a brief display area.

The full display area is an area which can display, without limitation, various kinds of information using characters, icons, graphics, etc. In the full display area, much information can be presented to the user, but it is possible that viewing the real world through the HMD screen 25B is difficult due to the displayed (superimposed) information.

The non-display area is an area in which no information is displayed. When the user views the non-display area, the user can view the real world through the HMD screen 25B, without being hindered by the information displayed on the HMD screen 25B.

The brief display area is an area in which briefed information (extracted information) is displayed. The brief display area displays images of a symbol, such as an arrow, an icon, a character, etc., so that the user may easily understand meanings of display even with small display sizes, and so that the view field may hardly be hindered (e.g. the user may easily view the real world through the HMD screen 25B).

The area setting module 32 sets the entire area of the HMD screen (display) 25B to be a full display area (first area), when the area setting module 32 has been notified that the user is not moving. As illustrated in FIG. 5, when the user is not moving, the entire screen of the HMD screen 25B is set to be a full display area 511 that can display information without limitation. Incidentally, the area setting module 32 sets the entire area of the HMD screen (display) 25B to be the full display area (first area) 511, for example, when the HMD application program 202 is started, when the HMD 25 is connected to the computer 1, or when the HMD 25 connected to the computer 1 is powered on.

The display controller 33 displays information on the HMD screen (display) 25B of the HMD 25 worn by the user. The display controller 33 reads from a storage medium 41 data (e.g. text data, image data) for first information corresponding to the entirety of the screen 25B (i.e. information specified to be displayed on the entirety of the screen 25B). The display controller 33 then sends to the HMD display controller 25A a video signal for displaying the first information on the full display area 511. The HMD display controller 25A displays video (image) on the HMD screen 25B based on the received video signal. Thereby, the first information is displayed on the set full display area 511.

On the other hand, when the area setting module 32 has been notified that the user is moving, the area setting module 32 sets a full display area (first area) and a non-display area (second area) in the screen 25B, based on the user's line of sight. The area setting module 32 receives line-of-sight data indicative of the user's line of sight, which is output by, for example, the line-of-sight sensor 29, and then sets a full display area and a non-display area by using the line-of-sight data. This line-of-sight data is indicative of the user's line of sight, for example, at regular time intervals (e.g. in every 0.1 second).

To be more specific, using the line-of-sight data which is output during a first period (e.g. several seconds) by the line-of-sight sensor 29, the area setting module 32 detects a plurality of points on the screen 25B, which have been viewed by the user in the first period. The area setting module 32 detects, for example, points, at which the line of sight indicated by the line-of-sight data intersects with the screen 25B, as the points on the screen 25B which have been viewed by the user. Then, the area setting module 32 determines an area including these plural points to be a non-display area, and determines the area excluding the non-display area in the screen 25B (i.e. the area not including the points on the screen 25B which have been viewed by the user) to be a full display area.

In the meantime, the line-of-sight data may be indicative of not the user's line of sight, but points on the screen 25B which have been viewed by the user at regular time intervals (e.g. in every 0.1 second). In this case, the area setting module 32 can set a non-display area and a full display area by using a plurality of points on the screen 25B indicated by the line-of-sight data which has been output in the first period by the line-of-sight sensor 29.

Besides, the area setting module 32 may detect a plurality of points on the screen 25B, which have been viewed by the user by a threshold number of times or more during the first period. Specifically, the area setting module 32 can exclude points, which the line of sight has merely instantaneously passed through, from the points at which the line of sight intersects with the screen 25B. In this case, the area setting module 32 determines the area including a plurality of points, which have been viewed by the user by a threshold number of times or more, to be the non-display area, and determines the area excluding the non-display area in the screen 25B to be the full display area.

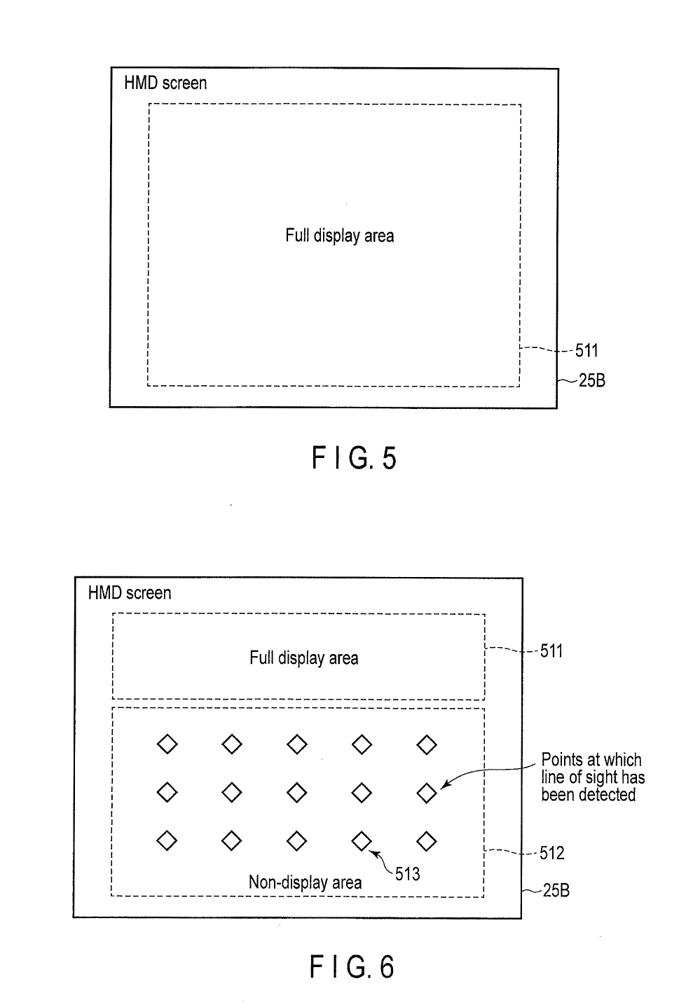

As illustrated in FIG. 6, when the user is moving, an area including a plurality of points (gaze points) 513, at which the user's line of sight has been detected, is set to be a non-display area 512 in which no information is displayed, and the other area is set to be a full display area 511. This non-display area 512 corresponds to, for example, a rectangular area including a plurality of points 513.

In response to the setting of the full display area (first area) 511 and non-display area (second area) 512, the display controller 33 displays second information which is part of the above-described first information (the information specified to be displayed on the entire screen) in the full display area 511. The display controller 33 then deletes, from the screen 25B, information displayed in the non-display area 512. To be more specific, the display controller 33 reads from the storage medium 41 data for information (second information) corresponding to the full display area 511 which is set at a part of the screen, and sends to the HMD display controller 25A a video signal for displaying the second information in the full display area 511. Based on the received video signal, the HMD display controller 25A displays video (image) on the HMD screen 25B. Thereby, the second information is displayed in the set full display area 511. The second information is, for example, a part of the above-described first information (the information to be displayed in the full display area 511 that is set on the entire screen).

In the meantime, when the area setting module 32 has been notified that the user is moving, the area setting module 32 may set a full display area (first area) 511 and a brief display area (second area) in the screen 25B, based on the user's line of sight.

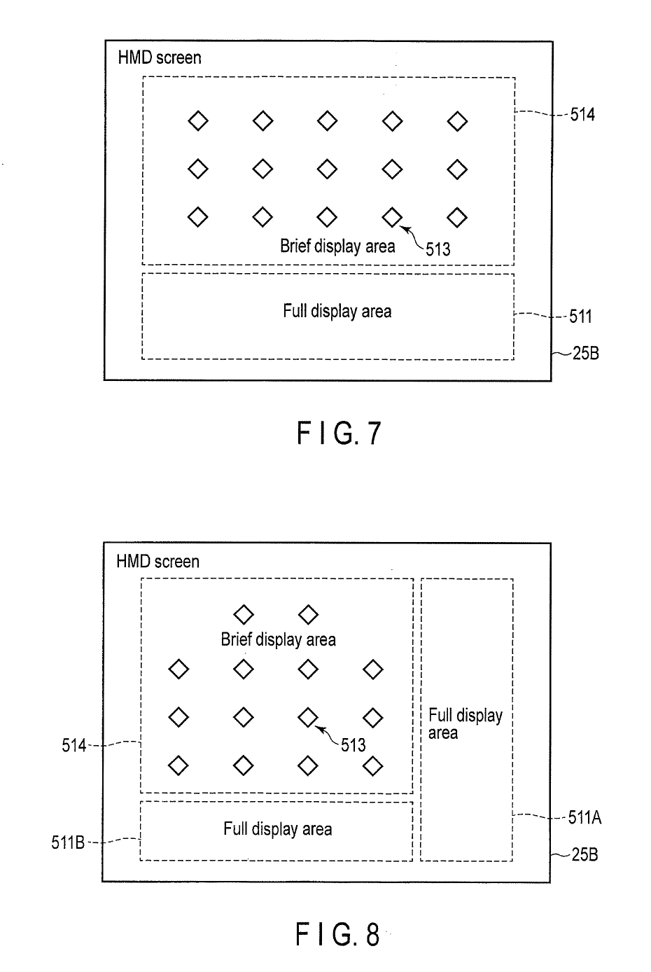

For example, as illustrated in FIG. 7, when the user is moving, an area including points (gaze points) 513, at which the user's line of sight has been detected, is set to be not a non-display area but a brief display area 514 in which briefed information (extracted information) is displayed.

In this case, the display controller 33 sends to the HMD display controller 25A a video signal for displaying second information in the full display area 511 and displaying third information in the brief display area 514. The HMD display controller 25A displays video (image) on the HMD screen 25B based on the received video signal. Thereby, the second information is displayed in the full display area 511, and the third information is displayed in the brief display area 514. The third information includes, for example, information which is extracted from (i.e. which is obtained by partly omitting) the first information excluding the second information.

Furthermore, as illustrated in FIG. 8, the area setting module 32 can set a plurality of areas of the same kind in the screen 25B. In the example illustrated in FIG. 8, the area setting module 32 sets a brief display area 514 including points 513 at which the user's line of sight has been detected, and two full display areas 511A and 511B corresponding to two rectangular areas which are obtained by dividing the area excluding the brief display area 514. Similarly, a plurality of brief display areas or a plurality of non-display areas may be set in the screen 25B.

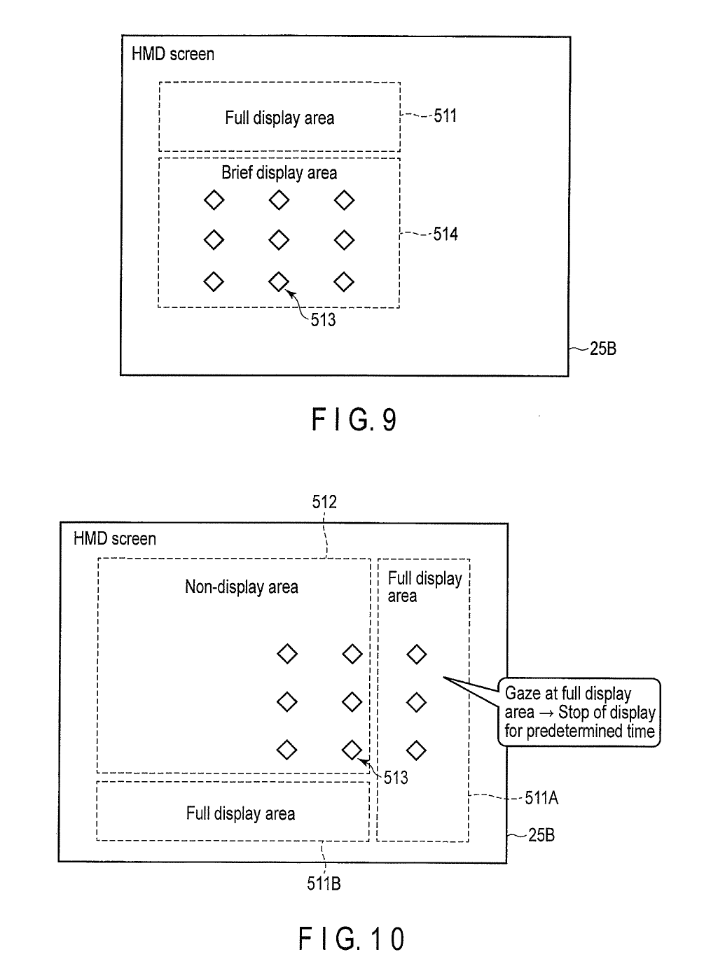

In general, the view field of the user becomes narrower in proportion to the moving velocity of the user. Thus, when the user is moving at a high velocity, for example, at a velocity higher than a threshold velocity, the area setting module 32 reduces the areas (full display area and brief display area) in which information is displayed. For example, by considering the narrowed view field, the area setting module 32 sets an area including points 513, which is included in a predetermined range based on points 513 at which the user's line of sight has been detected, to be the brief display area 514 (or non-display area). The area setting module 32 also sets the other area to be the full display area 511. As illustrated in FIG. 9, the brief display area 514 and full display area 511 are set in a smaller size than when the user is moving not at a high velocity (e.g. in the case of the example illustrated in FIG. 7). Thereby, even when the user is moving at a high velocity, information can safely be presented, considering the narrowed view field.

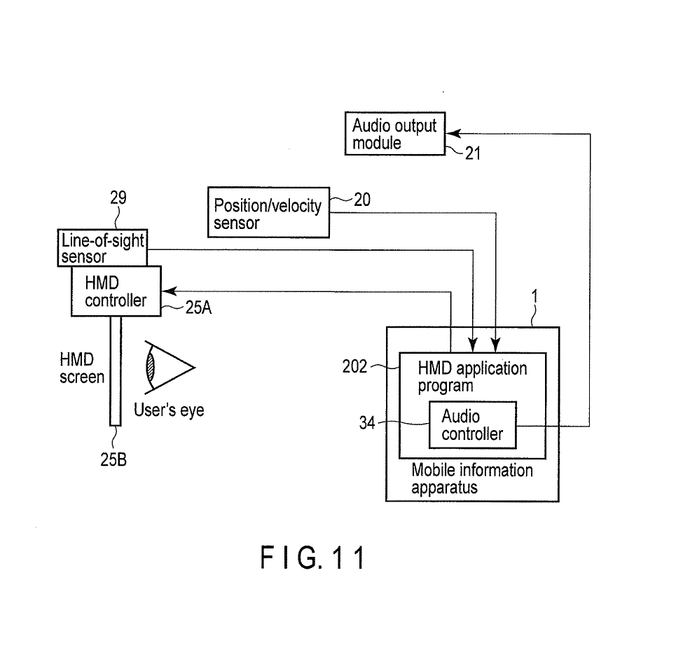

As illustrated in FIG. 10, after the second information was displayed in the full display area 511A, if the user gazes at the area 511A (e.g. if the user has continuously viewed the area 511A for a threshold period or more), the display of the information in the full display area 511A may be stopped for a predetermined time. The reason is that a danger may occur to the movement (walking, etc.) of the user if the user, while moving, gazes at the displayed information.

For example, the area setting module 32 uses line-of-sight data which has been output by the line-of-sight sensor 29 during a second period after the second information was displayed in the full display area 511A (first area), and thereby detects points 513 on the screen 25B which have been viewed by the user in the second period. Then, if the detected plural points 513 are included in the full display area 511A, the display controller 33 prohibits the second information from being displayed in the full display area 511A for a predetermined period (i.e. the display controller 33 outputs to the HMD 25 a video signal which does not display the second information).

In the meantime, as illustrated in FIG. 11, the HMD application program 202 may further includes an audio controller 34. In this case, audio information may be output to an audio output module 21 such as speakers 18A and 18B or headphone 16.

Specifically, when a non-display area or a brief display area has been set on the screen 25B, the area setting module 32 notifies the audio controller 34 that a part of information is not being displayed (i.e. the information is not fully displayed).

In response to this notification, the audio controller 34 detects, for example, information which is not displayed on the screen 25B because of the setting of a non-display area on the screen 25B, or information which has been omitted because of the setting of a brief display area on the screen 25B. The audio controller 34 then outputs audio corresponding to the detected information to the audio output module 21. Thereby, the information that is not displayed on the screen 25B, or the information that is omitted, can be provided to the user as audio information.

The state determination module 31 continuously monitors the movement state of the user. In addition, when the user is moving, the area setting module 32 continuously monitors the range of points (the user's line of sight) on the screen 25B, which are being viewed by the user. By such continuous monitoring, the state determination module 31 and area setting module 32 alter, when a great change occurs in the movement state or the line of sight, the position and range of the area (full display area, non-display area, brief display area) set on the screen 25B, and then updates the content of information displayed in the area.

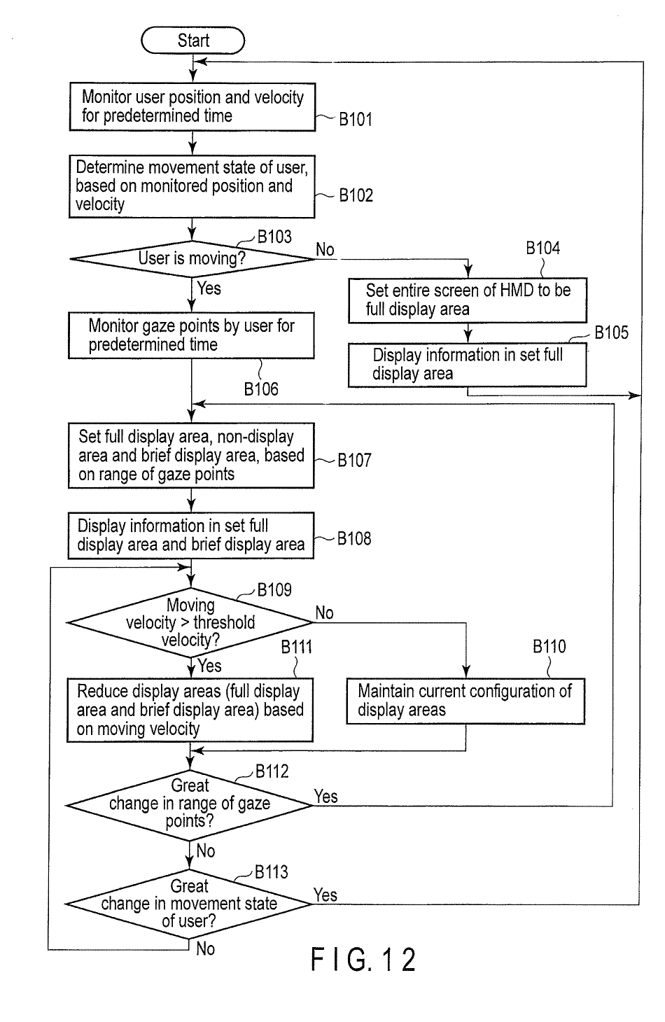

Next, referring to a flowchart of FIG. 12, a description is given of an example of the procedure of a display control process executed by the HMD application program 202.

To start with, the state determination module 31 monitors the position and the moving velocity of the user for a predetermined time (e.g. several seconds) (block B101). Then, based on the monitored position and velocity, the state determination module 31 determines the movement state of the user (block B102). Specifically, based on the monitored position and velocity, the state determination module 31 determines whether the user is moving or stands still.

Then, the state determination module 31 determines whether the user is moving or not (block B103). If the user is not moving (NO in block B103), the area setting module 32 sets the entirety of the screen 52B of the HMD to be a full display area 511 (block B104). Then, the display controller 33 displays information on the full display area 511 that has been set (block B105), and the process returns to block B101.

When the user is moving (YES in block B103), the area setting module 32 monitors gaze points 513 by the user for a predetermined time (e.g. several seconds) (block B106). Based on a range of the monitored gaze points 513 (hereinafter also referred to as “first range”), the area setting module 32 sets a full display area 511, a non-display area 512 and a brief display area 514 (block B107). The area setting module 32 sets, for example, an area including the monitored gaze points 513 to be the non-display area 512 (or brief display area 514), and sets the area in the screen excluding this non-display area 512 to be the full display area 511. Then, the display controller 33 displays information in the full display area 511 (and brief display area 514) which has been set (block B108).

Subsequently, the state determination module 31 determines whether the moving velocity of the user has exceeded a threshold velocity (block B109). When the moving velocity of the user has not exceeded the threshold velocity (NO in block B109), the area setting module 32 maintains the current configuration of display areas (block B110). On the other hand, when the moving velocity of the user has exceeded the threshold velocity (YES in block B109), the area setting module 32 reduces the display areas (i.e. full display area 511 and brief display area 514), based on the moving velocity (block B111).

Next, the area setting module 32 determines whether a great change has occurred in the range of the user's gaze points (block B112). For example, the area setting module 32 continuously monitors the user's gaze points. Then, the area setting module determines that a great change has occurred in the range of the user's gaze points, when a displacement between the current range (second range) of gaze points and the first range (e.g. the size of an area where the first range and second range do not overlap) is a threshold or more. When a great change has occurred in the range of gaze points (YES in block B112), the process returns to block B107, and a process based on the new range of gaze points is executed.

When no great change has occurred in the range of gaze points (NO in block B112), the state determination module 31 determines whether a great change has occurred in the movement state of the user (block B113). For example, the state determination module 31 continuously monitors the position and the moving velocity of the user, and determines that a great change has occurred in the movement state of the user, when the user, who had been moving, stopped.

When a great change has occurred in the movement state of the user (YES in block B113), the process returns to block B101, and a process for re-setting the configuration of display areas is executed. When no great change has occurred in the movement state of the user (NO in block B113), the process returns to block B109, and a process for changing the configuration of display areas, based on the moving velocity, is executed.

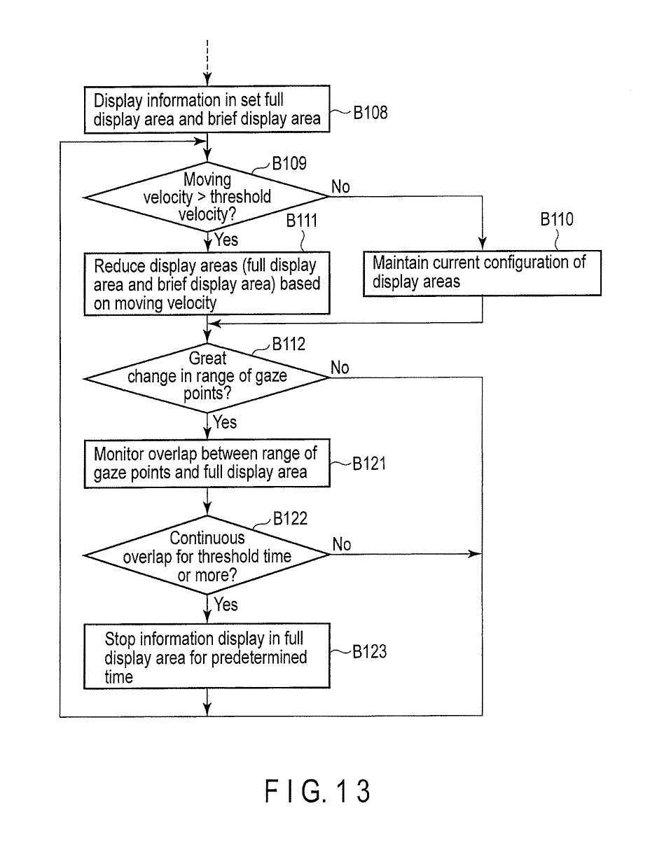

As illustrated in a flowchart of FIG. 13, a process corresponding to whether the user is gazing at the full display area 511 or not may be executed after the procedure of block B112 in FIG. 12. The procedure of block B108 to block B112 illustrated in FIG. 13 corresponds to the procedure denoted by the same reference signs in the flowchart of FIG. 12.

As has been described above, the area setting module 32 determines whether a great change has occurred in the range of the user's gaze points (block B112). When no great change has occurred in the range of gaze points (NO in block B112), the process returns to block B109.

On the other hand, when a great change has occurred in the range of gaze points (YES in block B112), the area setting module 32 monitors an overlap between the range of gaze points and the full display area 511 (block B121). Then, the area setting module 32 determines whether the range of gaze points and the full display area 511 continuously overlap for a threshold time or more (block B122). If the range of gaze points continuously overlaps with the full display area 511 for the threshold time or more (NO in block B122), the process returns to block B109.

If the range of gaze points continuously overlaps with the full display area 511 for the threshold time or more (YES in block B122), the display controller 33 stops display of information on the full display area 511 for a predetermined time (block B123), and the process returns to block B109. For example, the display controller 33 hides information in the full display area 511 for a predetermined time.

When the user wearing the HMD 25 gazes at information on the screen (HMD screen 25B) while moving, it is possible that the user, for example, fails to view an object in the real world or hits against an object in the real world, and this is dangerous. Thus, in the present embodiment, when the user gazes at information on the screen of the HMD 25, this information is deleted from the screen. Thereby, a danger to the user wearing the HMD 25 can be avoided.

As has been described above, according to the present, embodiment, when the user wearing the HMD 25 is moving, information can safely be presented to the user. The display controller 33 displays first information on the screen (HMD display) 25B of the HMD 25 which is worn by the user. The state determination module 31 determines whether the user is moving or not. When the user is moving, the area setting module 32 sets a first area (full display area) and a second area (non-display area or brief display area) in the screen 25B, based on the user's line of sight. In response to the setting of the first area and second area, the display controller 33 displays part of the first information in the first area, and deletes information displayed in the second area from the screen 25B. Thereby, as much as possible information can be displayed on the HMD screen 25B, while the user is not prevented from viewing the real world transmitted through the transmissive HMD screen 25B.

All the procedures of the display control process of the present embodiment can be executed by software. Thus, the same advantageous effects as with the present embodiment can easily be obtained simply by installing a computer program, which executes the procedures of the display control process, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display controller configured to display first information on a screen of a head-mounted display worn by a user;
a state determination module configured to determine whether the user is moving or not; and
an area setting module configured to set a first area and a second area in the screen based on a line of sight of the user if the user is moving,
wherein the display controller is configured to display, in response to the setting of the first area and the second area, second information in the first area and to delete information displayed in the second area from the screen, the first information comprising the second information.

2. The electronic apparatus of claim 1, wherein the area setting module is configured to set the first area and the second area by using line-of-sight data indicative of the line of sight of the user, the line-of-sight data being output from a line-of-sight sensor.

3. The electronic apparatus of claim 2, wherein the area setting module is configured to detect, by using the line-of-sight data output from the line-of-sight sensor during a first period, points on the screen, which have been viewed by the user during the first period, to set an area comprising the points to be the second area, and to set an area excluding the second area in the screen to be the first area.

4. The electronic apparatus of claim 2, wherein the area setting module is configured to detect, by using the line-of-sight data output from the line-of-sight sensor during a second period after the second information is displayed in the first area, points on the screen, which have been viewed by the user during the second period, and
the display controller is configured to not display the second information in the first area for a predetermined period, if the first area comprises the points.

5. The electronic apparatus of claim 1, wherein the area setting module is configured to set an entirety of the screen to be the first area, if the user is not moving, and
the display controller is configured to display the first information in the first area in response to the setting of the first area.

6. The electronic apparatus of claim 1, wherein the state determination module is configured to determine whether the user is moving or not, by using position data indicative of a position of the user, the position data being output from a position sensor.

7. The electronic apparatus of claim 1, wherein the area setting module is configured to set the first area and the second area based on the line of sight of the user and a moving velocity of the user.

8. The electronic apparatus of claim 7, wherein the area setting module is configured to set the first area and the second area by using line-of-sight data and velocity data, wherein the line-of-sight data is indicative of the line of sight of the user and is output from a line-of-sight sensor, and the velocity data is indicative of the moving velocity of the user and is output from a velocity sensor.

9. The electronic apparatus of claim 7, wherein the area setting module is configured to reduce the first area, if the moving velocity of the user has exceeded a threshold velocity after the setting of the first area.

10. The electronic apparatus of claim 1, wherein the display controller is configured to display, in response to the setting of the first area and the second area, the second information in the first area, and to display information, which is extracted from the first information excluding the second information, in the second area.

11. The electronic apparatus of claim 1, further comprising an audio controller configured to output audio corresponding to the first information excluding the second information.

12. A display control system comprising an electronic apparatus and a head-mounted display which are connected to each other, the electronic apparatus comprising:
a display controller configured to display first information on a screen of the head-mounted display worn by a user;
a state determination module configured to determine whether the user is moving or not; and
an area setting module configured to set, when the user is moving, a first area and a second area in the screen based on a line of sight of the user,
wherein the display controller is configured to display, in response to the setting of the first area and the second area, second information in the first area, and to delete information displayed in the second area from the screen, the first information comprising the second information.

13. A display control method comprising:
displaying first information on a screen of a head-mounted display worn by a user;
determining whether the user is moving;
setting a first area and a second area in the screen based on a line of sight of the user when the user is moving;
displaying, in response to the setting of the first area and the second area, second information in the first area and deleting information displayed in the second area from the screen, the first information comprising the second information.
